(19) United States
(12) Patent Application Publication
(10) Pub. No.: US 2017/0144767 A1
(43) Pub. Date: May 25, 2017

(54) HEAT EXCHANGER

(71) Applicant: Hamilton Sundstrand Corporation, Windsor Locks, CT (US)

(72) Inventors: Luke J. Mayo, Coventry, CT (US); Brian R. Shea, Windsor, CT (US)

(21) Appl. No.: 14/947,328

(22) Filed: Nov. 20, 2015

(51) Int. Cl. B64D 13/08; B64D 13/02; F28F 3/08; F28F 13/06; F28D 9/00; F28F 3/02

(52) U.S. Cl. CPC B64D 13/08; F28D 9/0037; F28F 3/025; F28F 3/08; F28F 13/06; B64D 13/02; B64D 2013/0603

(57) ABSTRACT

A recirculation heat exchanger for use in an environmental control system of an aircraft is provided including a rectangular core having a plurality of alternately stacked first fluid layers and second fluid layers. The rectangular core has a width of about 4.750 inches (12.065 cm), and a length of about 10.6 inches (26.924 cm). A first air header is arranged adjacent a first surface of the core and a second air header is arranged adjacent a second, opposite surface of the core. The first and second air header form a portion of a flow path for a first fluid. A first fluid header is arranged adjacent a third surface and a second fluid header is arranged adjacent a fourth surface of the core. The first and second fluid header form a flow path for the second fluid having a multi-pass configuration.

### BACKGROUND OF THE INVENTION

Exemplary embodiments of this invention generally relate to environmental control systems of an aircraft and, more particularly, to a recirculation heat exchanger of such an environmental control system.

Environmental control systems (ECS) for aircrafts and other vehicles are utilized to provide a conditioned airflow for passengers and crew within an aircraft cabin. One type of environmental control system generally operates by receiving fresh air from a ram air intake located near the ECS equipment bay. The fresh ram air is supplied to at least one electric motor-driven air compressor that raises the air pressure to, for example, the desired air pressure for the cabin. From at least one air compressor, the air is supplied to an optional ozone converter. Because air compression creates heat, the air is then supplied to an air conditioning pack in which the air is cooled before being transported to the cabin.

The air drawn from the cabin, also referred to as recirculation air, is provided to a recirculation heat exchanger where the air is cooled before being mixed with cool fresh air and returned to the cabin. As the size of aircraft cabins and cabin heat loads increase, the demands placed on the ECS also increase. A conventional ECS has difficulty meeting the greater cooling requirements of such an aircraft.

### BRIEF DESCRIPTION OF THE INVENTION

According to one embodiment of the invention, a recirculation heat exchanger for use in an environmental control system of an aircraft is provided including a rectangular core having a plurality of alternately stacked first fluid layers and second fluid layers. The rectangular core has a width of about 4.750 inches (12.065 cm), and a length of about 10.6 inches (26.924 cm). A first air header is arranged adjacent a first surface of the core and a second air header is arranged adjacent a second, opposite surface of the core. The first and second air header form a portion of a flow path for a first fluid. A first fluid header is arranged adjacent a third surface and a second fluid header is arranged adjacent a fourth surface of the core. The first and second fluid header form a flow path for the second fluid having a multi-pass counter-flow configuration.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an environmental control system of an aircraft;

FIG. 2 is a perspective view of a recirculation heat exchanger according to an embodiment of the invention;

FIG. 3 is an perspective view of a core of the recirculation heat exchanger of FIG. 2 according to an embodiment of the invention;

FIG. 4 is a front view of an example of a first fluid layer of the core according to an embodiment of the invention; and

FIG. 5 are is a front view of an example of second fluid layer of the core according to an embodiment of the invention.

The detailed description explains embodiments of the invention, together with advantages and features, by way of example with reference to the drawings.

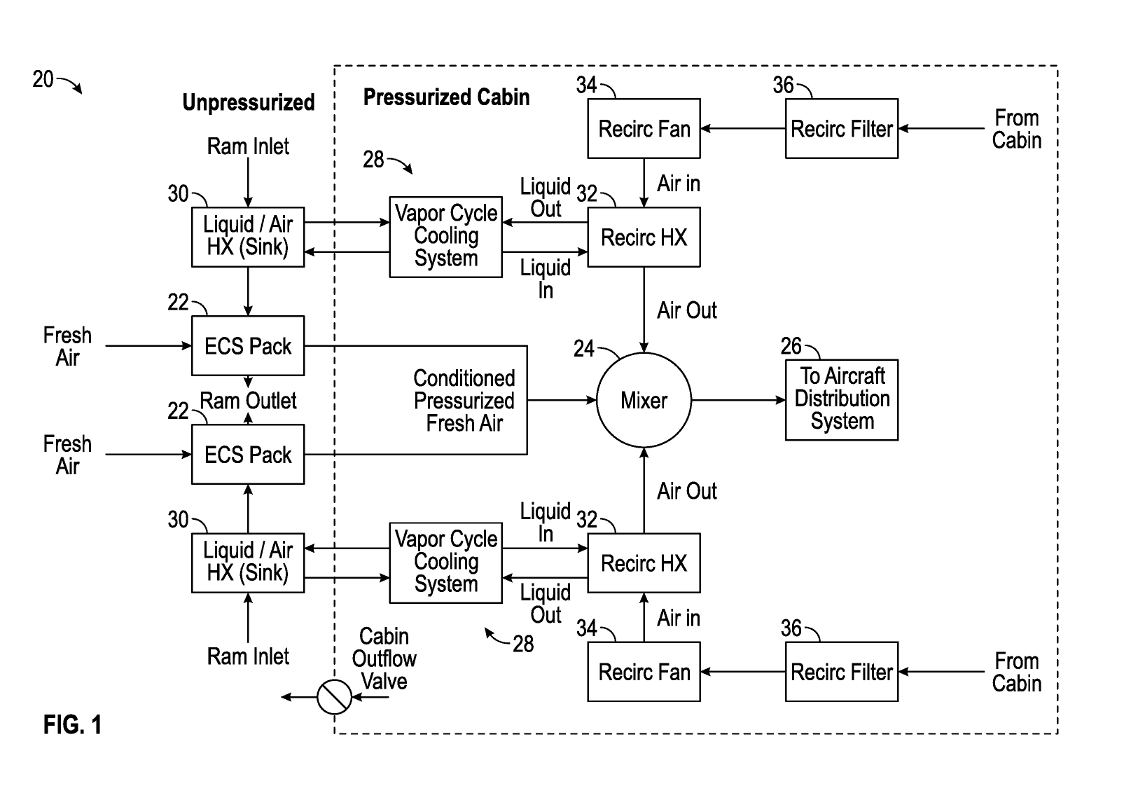

Referring now to FIG. 1, a schematic diagram of an example of an environmental control system (ECS) 20 of an aircraft is illustrated in more detail. The ECS 20 is configured to receive air from both an exterior of the aircraft, as fresh ram air, and from the aircraft fuselage or another interior space as recirculation air. Fresh ram air is supplied to an ECS pack 22 including a plurality of conventional components including at least one heat exchanger (not shown). Within the ECS pack 22, the fresh air is conditioned via heat exchange with ram air such that cool pressurized air is provided to a downstream mixer 24 and then to an aircraft distribution system 26.

Before being provided to the ECS pack 22, the ram air is configured to pass through a heat exchanger 30 of a liquid cooling circuit 28. Within the heat exchanger 30, the ram air is configured to absorb heat, thereby cooling the liquid within the vapor cooling circuit 28. The liquid cooling circuit 28 additionally includes a recirculation heat exchanger 32.

A majority of the recirculation air is transferred from a cabin back to the ECS 20 using a recirculation fan 34. The recirculation fan 34 is configured to draw the recirculation air through a filter 36 before supplying the recirculation air to the recirculation heat exchanger 32 for cooling. The cooled recirculation air leaves the recirculation heat exchanger 32 and is then mixed with the fresh air in mixer 24 before being supplied to the aircraft distribution system 26.

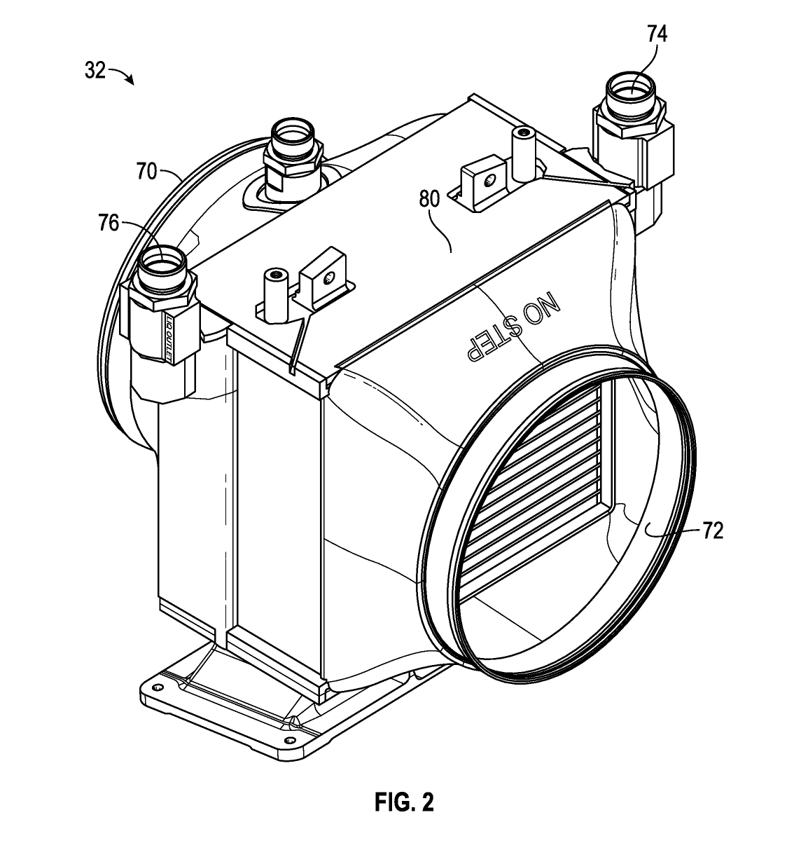

Referring now to FIG. 2, an example of a recirculation heat exchanger 26 is illustrated in more detail. The recirculation heat exchanger 26 is generally rectangular in shape. An air inlet header 70, an air outlet header 72, a liquid inlet header 74, and a liquid outlet header 76 are arranged in fluid communication with a core 80 of the heat exchanger 32 such that heat is configured to transfer from the recirculation air to the liquid within the heat exchanger 32. As illustrated, the air inlet header 70 and the air outlet header 72 are disposed adjacent opposite surfaces, such as a front and back of the core 80 for example. However, in other embodiments, such as where the air flow within the heat exchanger 32 has a multi-pass configuration, the air inlet 70 and the air outlet 72 may be located adjacent the same surface of the core 80. Similarly, the liquid inlet 74 and the liquid outlet 76 illustrated in FIG. 2 are arranged adjacent opposing surfaces of the core 80, for example, a right side and left side of the core 80, respectively. However, in other embodiments, such as where the liquid flow path through the heat exchanger 32 has a multi-pass configuration, the liquid inlet 74 and liquid outlet 76 may be arranged on the same side of the core 80.

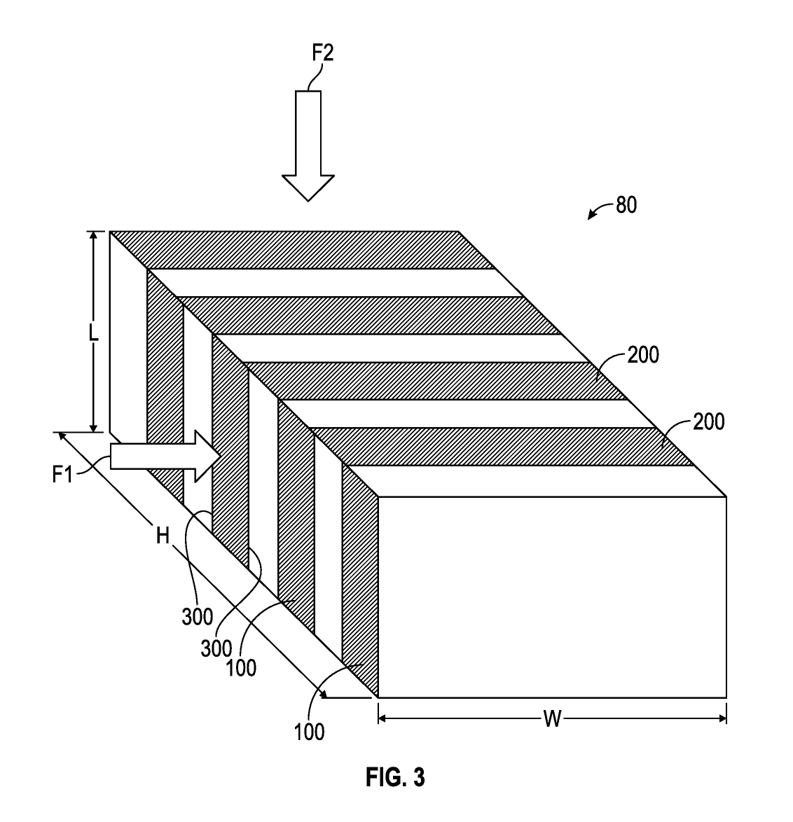

Details of the construction of the core 80 of the recirculation heat exchanger 32 are illustrated in FIGS. 3 - 5. More particularly, the core 80 of the recirculation heat exchanger 32 has a plate-fin construction with crossflow of a first warm fluid (air) and a second cool fluid there through. In one embodiment, the core 80 has a width W of about 4.750 inches (12.065 cm), and a length L of about 10.6 inches (26.924 cm). The core 80 of the heat exchanger 32 includes a plurality of first fluid layers 100 and second fluid layers 200. The first fluid layers 100 have a fluid pathway such that a first fluid, such as warm recirculation air for example, flows through the core 80 in a first direction, indicated by arrow F1. The second fluid layers 200 have a fluid pathway such that a second fluid, for example liquid coolant, flows through the core 80 in a second direction, indicated by arrow F2. In one embodiment, the direction of the second fluid flow is substantially perpendicular to the direction of the first fluid flow. The first and second fluid layers 100, 200 are alternately stacked along the height H of the core. Thin plates 300 separate adjacent fluid layers 100, 200. In one embodiment, the thin plates 300 have a thickness of about 0.016 inches (0.0406 cm).

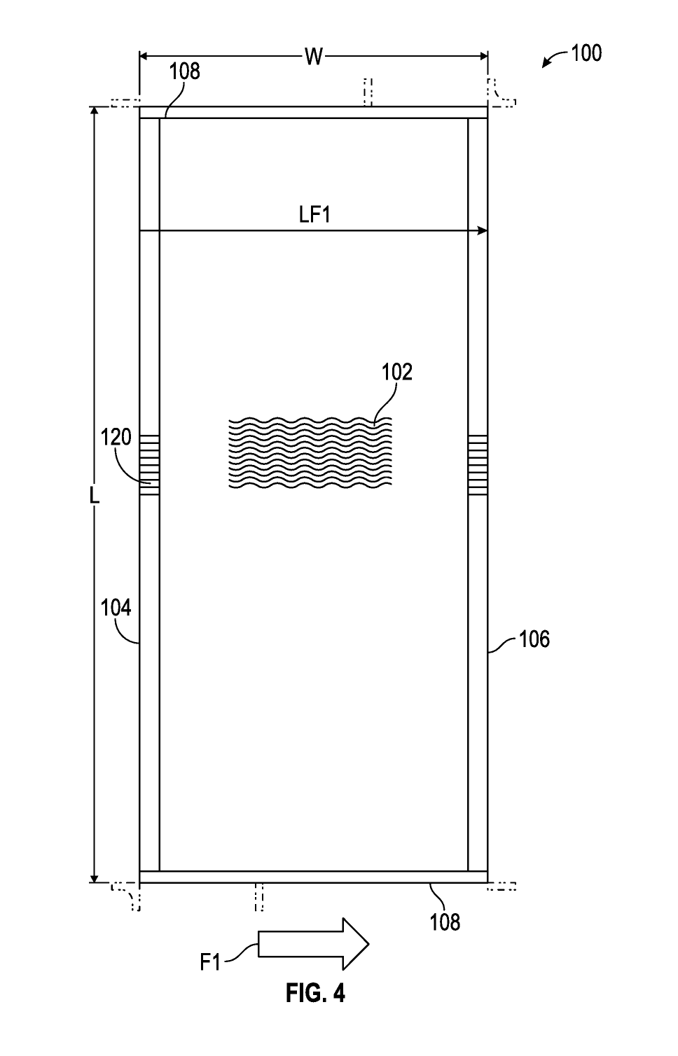

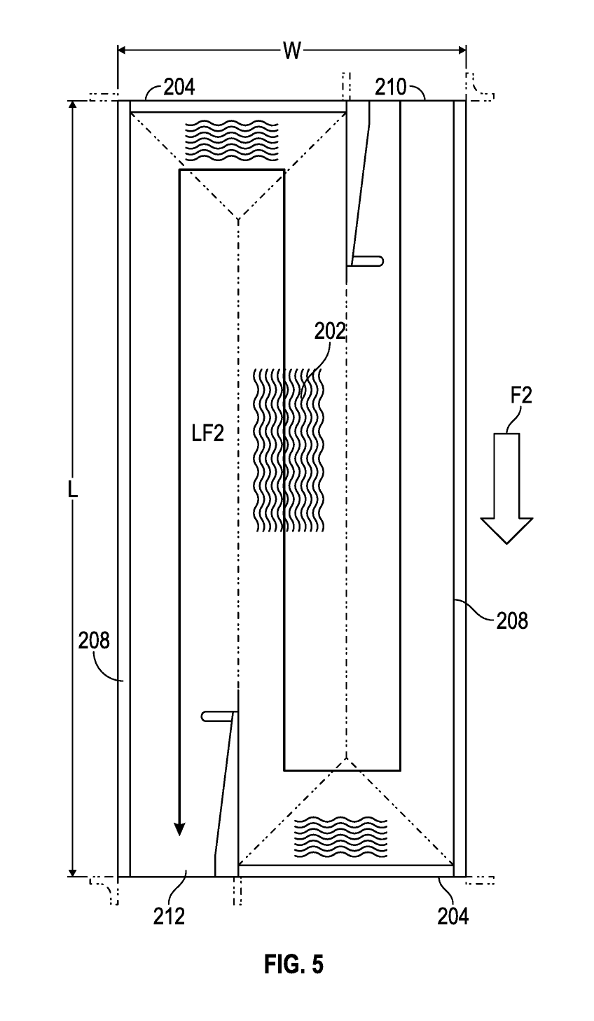

Referring to FIGS. 4-5, an example of a first fluid layer 100 and second fluid layer 200 are, respectively, illustrated. Each first fluid layer 100 and second fluid layer 200 has a plurality of corrugated fins 102, 202, respectively, that form a fluid pathway across each fluid layer. The corrugated fins 102 of the exemplary first fluid layer 100 extend from adjacent a first, inlet edge 104 fluidly coupled to the air inlet 70 to a second, outlet edge 106 fluidly coupled to the air outlet 72. The distance that the first fluid flows across the first fluid layer 100, between the inlet and outlet edges 104, 106, is the first fluid flow length LF1. Similarly, the corrugated fins 202 of the exemplary second fluid layer 200 extend between a first, inlet edge 210 fluidly coupled to the liquid inlet header 74 to a second, outlet edge 212 of the layer 200 fluidly connected to a liquid outlet 76. The fins 202 of the second fluid layer 200 may be arranged to define multiple passes within each layer 200. In the illustrated, non-limiting embodiment, each second fluid layer 200 has a three-pass, counter-flow configuration. The total distance of the flow path of a second fluid through a second fluid layer 200 is the second fluid flow length LF2.

The fin configurations of both the first fluid layers 100 and the second fluid layers 200 may, but need not, remain constant over the height H of the core 80. The configurations of the corrugated fins 102, 202 of the first and second fluid layers 100, 200 are defined by a fin height, a fin thickness, and the number of fins per length. The corrugated fins 102 of the first fluid layers 100 have a fin height about 0.324 inches (0.8230 cm), a fin thickness of about 0.003 inches (0.0076 cm), and a fin density of about 26.5 fins/inch (10.43 fins/cm). The corrugated fins 202 of the second fluid layers 200 have a fin height about 0.087 inches (0.2210 cm), a fin thickness of about 0.004 inches (0.0106 cm), and a fin density of about 30 fins/inch (11.81 fins/cm). The other edges of the layers, excluding the inlet and outlet edges 104, 106, are covered by closure bars 108, 204, 208, to prevent fluid flow in an alternate path. In one embodiment, the closure bars 108, 204, 208 have a width or height of about 0.150 inches (0.381 cm).

As shown in FIG. 4, the fin configuration of a first fluid layer 100 is not uniform across the flow length of the layer. In one embodiment, adjacent the inlet 104 and outlet 106 of each first fluid layer 100 is a guard fin 120. The guard fin 120 may have a straight or corrugated configuration. The guard fin 120 of a first fluid layer 100 may have a fin height of about 0.324 inches (0.86 cm), a fin thickness of about 0.012 inches (0.0305 cm) and a fin density of about 9 fins per inch (3.54 fins per cm).

Within the recirculation heat exchanger, the warm recirculation air from the aircraft cabin is cooled using a liquid coolant. Further, depending upon the cooling requirements of the ECS and the air distribution architecture, the recirculation heat exchanger 32 may be arranged at a different location within the aircraft, compared to a conventional ECS. In one embodiment, the recirculation heat exchanger 32 is positioned within a distribution bay. In other embodiments, the recirculation heat exchanger 32 is located within an unpressurized equipment bay. By relocating the recirculation heat exchanger 32 the size of the heat exchanger may be increased, resulting in more effective heat transfer.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A recirculation heat exchanger for use in an environmental control system of an aircraft, comprising:
a rectangular core having a plurality of alternately stacked first fluid layers and second fluid layers, wherein the rectangular core has a width W of about 4.750 inches (12.065 cm), and a length L of about 10.6 inches (26.924 cm);
a first air header adjacent a first surface of the core;
a second air header adjacent a second, opposite surface of the core,
wherein the first air header and the second air header form a portion of a flow path for a first fluid;
a first fluid header adjacent a third surface of the core; and
a second fluid header adjacent a fourth surface of the core;
wherein the first fluid header and the second fluid header form a portion of a flow path for a second fluid and the flow path for the second fluid having a multi-pass counterflow configuration.

2. The recirculation heat exchanger according to claim 1, wherein each first fluid layer and second fluid layer includes a plurality of corrugated fins that extend between an inlet edge and an outlet edge to form a flow path for a fluid.

3. The recirculation heat exchanger according to claim 2, wherein at least one first fluid layer includes a plurality of corrugated fins having a fin height of about 0.324 inches (0.86 cm), a fin thickness of about 0.003 inches (0.0076 cm) and a fin density of about 26.5 fins per inch (10.43 fins per cm).

4. The recirculation heat exchanger according to claim 2, wherein at least one second fluid layer includes a plurality of corrugated fins having a fin height of about 0.087 inches (0.2210 cm), a fin thickness of about 0.004 inches (0.0106 cm) and a fin density of about 30 fins per inch (11.81 fins per cm).

5. The recirculation heat exchanger according to claim 3, further comprising a plurality of guard fins adjacent the inlet edge and outlet edge of the first fluid layer, wherein the guard fins have a first fin configuration and the plurality of corrugated fins have a second, different fin configuration.

6. The recirculation heat exchanger according to claim 5, wherein the guard fins have a fin height of about 0.324 inches (0.86 cm), a fin thickness of about 0.012 inches (0.0305 cm) and a fin density of about 9 fins per inch (3.54 fins per cm).

7. The recirculation heat exchanger according to claim 6, wherein the plurality of guard fins are straight.

8. The recirculation heat exchanger according to claim 2, wherein the plurality of first fluid layers and the plurality of second fluid layers are separated from one another by a plate having a thickness of about 0.016 inches (0.0406 cm).

9. The recirculation heat exchanger according to claim 1, wherein the second fluid layers have a three-pass, counter flow configuration.

10. The recirculation heat exchanger according to claim 1, where the flow path of the plurality of second fluid layers is perpendicular to the flow path of the plurality of second fluid layers.

11. The recirculation heat exchanger according to claim 1, wherein the recirculation heat exchanger is mounted within a distribution bay of the aircraft.
